(19) United States
(12) Patent Application Publication
(10) Pub. No.: US 2019/0389257 A1
(43) Pub. Date: Dec. 26, 2019

(54) Methods And Apparatuses For Transitioning To A Battery Storage Mode In Tire Pressure Monitoring Systems

(71) Applicant: Doran Mfg. LLC, Cincinnati, OH (US)

(72) Inventor: Jie Shen, Shanghai (CN)

(73) Assignee: Doran Mfg. LLC, Cincinnati, OH (US)

(21) Appl. No.: 16/451,869

(22) Filed: Jun. 25, 2019

Related U.S. Application Data
(60) Provisional application No. 62/690,050, filed on Jun. 26, 2018.

(51) Int. Cl. B60C 23/04; B60C 23/00; H02J 7/00; H04Q 9/00

(52) U.S. Cl. CPC B60C 23/041; B60C 23/003; H04Q 2209/883; H02J 7/0052; H04Q 9/00; B60C 23/009

(57) ABSTRACT

A method includes operating a transceiver of a tire pressure monitoring system in an active operation mode, where the transceiver includes a battery and a data storage device. The method includes determining whether the transceiver is coupled to an external power source, and determining whether the data storage device of the transceiver includes sensor identifier data stored thereon when the transceiver is not coupled to the external power source. The method further includes transitioning the transceiver from the active operation mode to a battery storage mode when the data storage device does not include sensor identifier data stored thereon and the transceiver is not coupled to the external power source.

### CROSS-REFERENCE TO RELATED APPLICATIONS

This application claims the benefit of U.S. Provisional Patent Application No. 62/690,050, filed Jun. 26, 2018 and entitled “Method And Apparatus For Battery Power Storage In A Tire Pressure Monitoring System.”

### TECHNICAL FIELD

The present specification generally relates to methods and apparatuses for transitioning to a battery storage mode, and more particularly to methods and apparatuses for transitioning to a battery storage mode in tire pressure monitoring systems.

### BACKGROUND

Tire pressure monitoring systems may generally include a transceiver attached to a vehicle and communicatively coupled to one or more sensors mounted thereon, and more specifically on one or more tires of the vehicle. A transceiver of a tire pressure monitoring system may transmit data detected by the one or more sensors to a user interface device. Such transceivers are generally battery-powered and undergo quality control testing during a manufacturing process prior to being utilized in the field. During said testing processes, a transceiver may be coupled to an external power source to charge an internal battery of the transceiver while the testing procedures are performed. A transceiver that completes testing may be decoupled from the external power source such that a battery of the transceiver is activated to continue power supply to the transceiver.

In this instance, transceivers may be shipped and/or stored away for future use. However, with an internal battery of a transceiver having been activated upon disconnection with an external power source, a battery life of the transceiver may gradually diminish during the shipping and/or storage process such that a remaining battery life of the transceiver is substantially reduced once employed in the field for use.

Accordingly, a need exists for transitioning to a battery storage mode in tire pressure monitoring systems.

### SUMMARY

In one embodiment, a method includes operating a transceiver of a tire pressure monitoring system in an active operation mode, where the transceiver includes a battery and a data storage device. The method includes determining whether the transceiver is coupled to an external power source, and determining whether the data storage device of the transceiver includes sensor identifier data stored thereon when the transceiver is not coupled to the external power source. The method further includes transitioning the transceiver from the active operation mode to a battery storage mode when the data storage device does not include sensor identifier data stored thereon and the transceiver is not coupled to the external power source.

In another embodiment, a transceiver includes a battery configured to power the transceiver, a processor, a data storage device, and a memory including one or more programming instructions that, when executed by the processor, cause the processor to determine whether the transceiver is coupled to an external power source, determine whether sensor identifier data of at least one sensor is stored in the data storage device, and in response to determining the sensor identifier data of the at least one sensor is not stored in the data storage device and determining the transceiver is not coupled to the external power source, transition the transceiver from an active operation mode to a battery storage mode.

In another embodiment, a tire pressure monitoring system includes at least one sensor and a transceiver. The at least one sensor is coupled to at least one tire of a vehicle, and includes a sensor identifier. The transceiver includes a battery, a processor, a data storage device, and a memory including one or more programming instructions that, when executed by the processor, cause the processor to determine whether the transceiver is coupled to an external power source, determine whether the data storage device includes the sensor identifier stored therein, and transition the transceiver from an active operation mode to a battery storage mode in response to determining the data storage device does not include the sensor identifier stored therein and determining the transceiver is not coupled to the external power source.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a tire pressure monitoring system according to one or more embodiments shown and described herein;

FIG. 2 schematically depicts illustrative hardware components of a transceiver used in a tire pressure monitoring system according to one or more embodiments shown and described herein; and

FIG. 3 depicts a flow diagram of an illustrative method according to one or more embodiments shown and described herein.

### DETAILED DESCRIPTION

The present disclosure relates generally to apparatuses and methods that transition transceivers of tire pressure monitoring systems to a battery storage mode. Embodiments described herein may provide battery power maintenance for a transceiver of a tire pressure management system when the transceiver is in an inoperable state. A method includes operating a transceiver of a tire pressure monitoring system in an active operation mode, where the transceiver includes a battery and a data storage device. The method includes determining whether the transceiver is coupled to an external power source, and determining whether the data storage device of the transceiver includes sensor identifier data stored thereon when the transceiver is not coupled to the external power source. The method further includes transitioning the transceiver from the active operation mode to a battery storage mode when the data storage device does not include sensor identifier data stored thereon and the transceiver is not coupled to the external power source. Such a method may facilitate the preservation of battery power of a transceiver of a tire pressure management system during shipping and/or storage of the tire pressure management system.

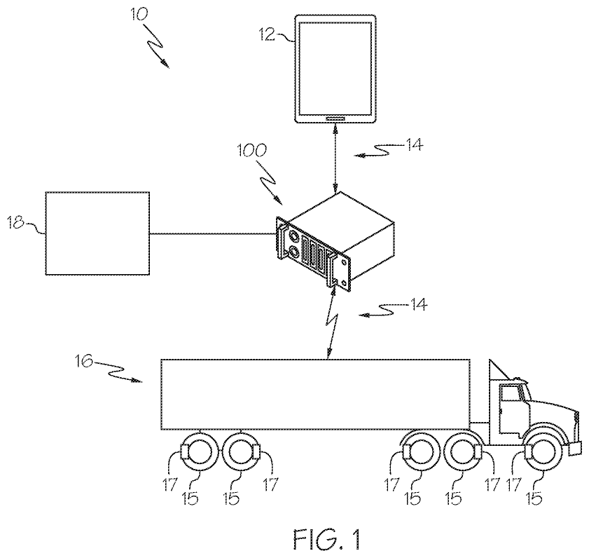

Referring now to the drawings, FIG. 1 depicts an illustrative tire pressure monitoring system 10 according to embodiments shown and described herein. As illustrated in FIG. 1, the tire pressure monitoring system 10 utilizes one or more networks 14 to communicatively couple components of the tire pressure monitoring system 10. In some embodiments, the one or more networks 14 may include one or more wired and/or wireless communication networks. Illustrative systems, components, and/or devices of the tire pressure monitoring system 10 may include, but are not limited to, a computing device 12, an external power source 18, sensors 17 configured to measure one or more characteristics (e.g., temperature, pressure, etc.) of tires 15 of a vehicle 16 (e.g. a truck), and a transceiver 100. In some embodiments, one or more components of the tire pressure monitoring system 10 may not be communicatively coupled to the one or more networks 14, such as embodiments in which no computing device 12 is present. In some embodiments, the external power source 18 is communicatively coupled to the transceiver 100, though in other embodiments, the external power source 18 is not communicatively coupled to the transceiver 100. While the transceiver 100 is depicted in FIG. 1 as separate from the vehicle 16, it should be understood that this merely for illustrative purposes only, and that in embodiments the transceiver 100 may be mounted to or physically coupled to the vehicle 16.

The computing device 12 is a remote, computing device that provides an interface between an operator of the tire pressure monitoring system 10 and the other components of the tire pressure monitoring system 10 via the one or more networks 14. In some embodiments, the computing device 12 is a smart tablet that is separate from the vehicle 16 and the transceiver 100. In some embodiments, the computing device 12 is a component of the vehicle 16, such as embodiments in which the computing device 12 is integrated in the cab of the vehicle 16. The computing device 12 may be used to perform one or more user-facing functions of the tire pressure monitoring system 10, such as allowing a user to analyze data received from another component of the tire pressure monitoring system 10 or inputting information to be transmitted to other components of the tire pressure monitoring system 10 (e.g., transceiver 100), as described in greater detail herein. Accordingly, the computing device 12 may include at least a display and/or input hardware for facilitating the one or more user-interfacing functions, as described in greater detail herein. The computing device 12 may also be used to input additional data into the tire pressure monitoring system 10 that supplements the data stored and received from the transceiver 100. For example, the computing device 12 may contain software programming or the like that allows a user to view sensor data detected by one or more sensors 17 positioned on each of a plurality of vehicles 16, and provide supplemental information accordingly, such as threshold alerts for the sensor data detected by the one or more sensors 17, as described in greater detail herein.

The vehicle 16 may generally be any vehicle including the sensors 17 positioned on or within the vehicle 16, as described in greater detail herein. In some embodiments, the vehicle 16 includes one or more onboard computing devices that contain hardware and/or software for transmitting and/or processing data received from sensors 17 positioned on or within the vehicle 16. In some embodiments, the computing devices may contain hardware for interacting with the other components of the vehicle 16 and/or a user of the vehicle 16, where the devices may be operable to communicate a notification when data is transmitted from the vehicle 16 to a remote server (e.g., computing device 12, transceiver 100). It should be understood that while FIG. 1 only depicts a single vehicle 16 for the purposes of simplicity, the present disclosure is not limited to such. That is, the tire pressure monitoring system 10 may include a plurality of vehicles 16 such that the battery power storage operabilities of the tire pressure monitoring system 10 can be simultaneously implemented for each of the plurality of vehicles 16. In the present example, the vehicle 16 is a semi, tractor-trailer truck including a plurality of tires 15, though the vehicle 16 is merely an illustrative example of a vehicle 16 within the scope of the present disclosure.

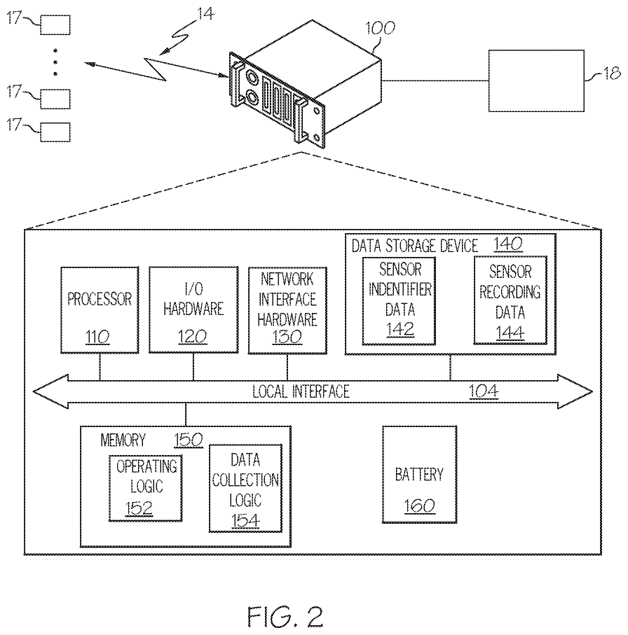

The external power source 18 is a device that serves as an electrical power supply to one or more components and/or devices of the tire pressure monitoring system 10 according to embodiments described herein. In some embodiments, the external power source 18 is configured to provide electrical power to the transceiver 100, and more specifically to a battery 160 of the transceiver 100 (See FIG. 2). The external power source 18 is operable to provide power to the one or more components and/or devices of the tire pressure monitoring system 10 via various suitable mechanisms, including one or more wired connections, wireless signals, and/or the like. In some embodiments, the external power source 18 is configured to deliver power generated at one or more power generation stations to the transceiver 100, such as by one or more standard power cords. In some embodiments, the external power source 18 is an electric battery or other power-distribution systems.

The transceiver 100 is a radio transmitter and receiver device that may receive data from one or more sources (e.g., the computing device 12, the vehicle 16, and/or the one or more sensors 17), analyze the received data, generate data, store data, index data, search data, and/or provide data to the computing device 12 and/or the vehicle 16 (or components thereof). More specifically, the transceiver 100 may employ one or more pressure and/or temperature estimation algorithms for the purposes of analyzing data that is received from the one or more sensors 17 of the vehicle 16, as described in greater detail herein.

It should be understood that while the computing device 12 is depicted as a tablet computing device and the transceiver 100 is depicted as a communications device, these are nonlimiting examples. In some embodiments, any type of computing device (e.g., mobile computing device, computer, server, cloud-based network of devices, etc.) may be used for any of these components. Additionally, while each of these computing devices is illustrated in FIG. 1 as a single piece of hardware, this is also merely an example. Each of the computing device 12 and the transceiver 100 may represent a plurality of computing devices, computers, servers, databases, components, and/or the like.

FIG. 2 schematically depicts illustrative hardware components of the transceiver 100 that may be integrated and used in the tire pressure monitoring system 10. In particular, the transceiver 100 may include a non-transitory computer-readable medium for completing the various processes described herein, embodied as hardware, software, and/or firmware, according to embodiments shown and described herein. The transceiver 100 may be a device separate from the vehicle 16 in some embodiments, and may be an onboard computing system that is installed in the vehicle 16 in other embodiments. In some embodiments, the transceiver 100 may be a plurality of computing systems. While in some embodiments the transceiver 100 may be configured as a general purpose computer with the requisite hardware, software, and/or firmware, in other embodiments, the transceiver 100 may also be configured as a special purpose computer designed specifically for performing the functionality described herein. In embodiments where the transceiver 100 is a general purpose computer, the methods described herein provide a mechanism for improving the functionality of the transceiver 100 by moving certain processor-intensive tasks away from the transceiver 100 to be completed by an external device that is more adapted for such tasks (e.g., the computing device 12).

The transceiver 100 may include, for example, a processor 110, I/O hardware 120, network interface hardware 130, a data storage device 140, a non-transitory memory component 150, and/or a battery 160. A local interface 104, such as a bus or the like, may interconnect the various components. The processor 110, such as a central processing unit (CPU), may be the central processing unit of the transceiver 100, performing calculations and logic operations to execute a program. The processor 110, alone or in conjunction with the other components, is an illustrative processor, computing device, processor, or combination thereof. The processor 110 may include any processing component configured to receive and execute instructions (such as from the data storage device 140 and/or the non-transitory memory component 150).

Still referring to FIG. 2, the non-transitory memory component 150 may be configured as a nonvolatile computer-readable medium and, as such, may include read only memory (ROM), flash memory, registers, compact discs (CD), digital versatile discs (DVD), and/or other types of storage components. The non-transitory memory component 150 may include one or more programming instructions thereon that, when executed by the processor 110, cause the processor 110 to complete various processes, such as certain processes described herein with respect to transitioning the transceiver 100 to a battery storage mode. The programming instructions stored on the non-transitory memory component 150 may be embodied as a plurality of software logic modules, where each logic module provides programming instructions for completing one or more tasks.

In some embodiments, the program instructions contained on the non-transitory memory component 150 may be embodied as a plurality of software modules, where each module provides programming instructions for completing one or more tasks. For example, FIG. 2 schematically depicts the non-transitory memory component 150 containing illustrative logic components according to one or more embodiments shown and described herein. The non-transitory memory component 150 may be configured to store various processing logic, such as, for example, operating logic 152 and/or data collection logic 154 (each of which may be embodied as a computer program, firmware, or hardware, as an example). The operating logic 152 may include an operating system and/or other software for managing components of the transceiver 100. As described in greater detail herein, the operating logic 152 of the transceiver 100 is configured to determine an operating state/mode of the transceiver 100 and transition the transceiver 100 between an active operation mode and a battery storage mode, respectively. The data collection logic 154 may contain one or more software modules for collecting data from one or more sources of the tire pressure monitoring system 10 (e.g., the one or more sensors 17 on the vehicle 16, and/or the like), converting data, transmitting data, and/or analyzing data, as described in greater detail herein.

Still referring to FIG. 2, the network interface hardware 130 may include any wired or wireless networking hardware, such as a modem. LAN port, wireless fidelity (Wi-Fi) card, WiMax card, mobile communications hardware, and/or other hardware for communicating with other networks and/or devices. For example, the network interface hardware 130 may provide a communications link between the transceiver 100 and the other components of the one or more networks 14 depicted in FIG. 1, including (but not limited to) the computing device 12, the sensors 17 of the vehicle 16, and/or the external power source 18 (e.g., in embodiments in which the external power source 18 is network-connected). The network interface hardware 130 of the transceiver 100 is operable to transmit sensor data relating to the sensors 17 (e.g. sensor identifier data 142) and/or one or more tires 15 of the vehicle 16 (e.g. sensor recording data 144) in response to the detection of data from the sensors 17 involving the tires 15, such as tire pressure and/or tire temperature properties of the one or more tires 15. In this instance, the processor 110 of the transceiver 100 executes transmission of the sensor data to the computing device 12 via the network interface hardware 130. In some embodiments, the network interface hardware 130 of the transceiver 100 is further operable to transmit a signal to the one or more networks 14 to determine whether the external power source 18 is coupled to the transceiver 100 such as embodiments in which the external power source 18 is network-connected and capable of transmitting a message to the transceiver 100 indicating that it is in power communication with the transceiver 100. In this instance, the processor 110 of the transceiver 100 executes transmission of the signal to the one or more networks 14 via the network interface hardware 130 to detect and/or determine a present connection of the external power source 18 thereto.

The data storage device 140, which may generally be a storage medium, may contain one or more data repositories for storing data that is received and/or generated. The data storage device 140 may be any physical storage medium, including, but not limited to, a hard disk drive (HDD), memory module, removable storage, and/or the like. While the data storage device 140 is depicted as a local device, it should be understood that the data storage device 140 may be a remote storage device, such as, for example, a server computing device or the like (e.g., computing device 12). The data storage device 140 of the transceiver 100 may contain various types of data therein according to one or more embodiments shown and described herein. The data storage device 140 may include, for example, sensor identifier data 142 that may include, for example, data received from the one or more sensors 17 of the vehicle 16, data manually inputted by a user of the vehicle 16 relating to the one or more sensors 17, and/or the like. In some embodiments, the sensor identifier data 142 is a unique serial number, an identification code, and/or other suitable information that serves to individually identify a particular sensor 17 from a plurality of sensors 17 included on the plurality of tires 15 of the vehicle 16 and included in the tire pressure monitoring system 10. In other words, the data storage device 140 is configured to store at least one sensor identifier data 142 for each of the sensors 17 coupled to the one or more tires 15 of the vehicle 16 that the transceiver 100 is communicatively coupled to (and in some embodiments securely attached to) via the one or more networks 14 of the tire pressure monitoring system 10. The data storage device 140 may further include, for example, sensor recording data 144 that may include, for example, data received from the one or more sensors 17 of the vehicle 16 relating to the tires 15 of the vehicle 16. In some embodiments, the sensor recording data 144 is tire pressure and/or tire temperature properties of the one or more tires 15 of the vehicle 16. It should be understood that in other embodiments, the data storage device 140 of the transceiver 100 may include additional data not depicted and described herein.

Still referring to FIG. 2, the I/O hardware 120 may communicate information between the local interface 104 and one or more other components of the tire pressure monitoring system 10, including the computing device 12, the vehicle 16, and/or the like. The I/O hardware 120 may further act as an interface between the transceiver 100 and other components, such as mobile phone systems, infotainment systems, and/or the like. In some embodiments, the I/O hardware 120 may be utilized to transmit one or more commands to the other components of the tire pressure monitoring system 10 based on one or more inputs received from a user via other monitoring components, such as, for example, an input from a user of the vehicle 16 to extract the sensor identifier data 142 and/or sensor recording data 144 from the one or more sensors 17 coupled to the tires 15 of the vehicle 16. The one or more sensors 17 coupled to the tires 15 of the vehicle 16 may include various hardware components for sensing characteristics of certain vehicle components, particularly sensed properties of the tires 15 such as at least a tire pressure and tire temperature.

By way of an illustrative example only, the vehicle 16 may include a plurality of tires 15 and a plurality of sensors 17 coupled to each of the plurality of tires 15. It should be understood that the plurality of sensors 17 are otherwise not limited by the present disclosure such that the vehicle 16 may include additional or fewer sensors 17 thereon. Illustrative characteristics that may be sensed by the plurality of sensors 17 may include other properties other than a pressure and a temperature of the tire 15 without departing from the scope of the present disclosure. It should be understood that the plurality of sensors 17 may be positioned on, integrated with, positioned in line with, or positioned adjacent to one or more other features or devices of the vehicle 16 other than the plurality of tires 15 without departing from the scope of the present disclosure. By way of further example, the plurality of sensors 17 may be a speed sensor, an acceleration/deceleration sensor, a force/impact sensor, a pressure sensor, a temperature sensor, a GPS location sensor, and/or the like. In the present example, the plurality of sensors 17 may be sensors mounted to a valve stem of the tires 15 of the vehicle 16 that are in wireless communication with the transceiver 100 via the one or more networks 14. The sensors 17 of the vehicle 16 are programmed and operable to detect, measure, and record data in response to the occurrence of an event, such as an input command from a user of the tire pressure monitoring system 10. In this instance, the processor 110 of the transceiver 100 is operable to initiate activation of the plurality of sensors 17.

In some embodiments, the I/O hardware 120 may be utilized to transmit sensor recording data 144 and/or a notification alert based on sensor recording data 144 to the computing device 12. For example, the operating logic 152 of the transceiver 100 may be configured to analyze sensor recording data 144 from the one or more sensors 17 and generate a notification alert of a warning to be transmitted to the computing device 12, including a low or high pressure alert, a low or high temperature alert, or an active leak alert of the tire 15. The data collection logic 154 of the transceiver 100 may include programming instructions that, when executed by the processor 110, periodically perform one or more processes for determining a connection of the external power source 18 to the transceiver 100, for determining a presence and/or inclusion of the sensor identifier data 142 in the data storage device 140, and/or the like.

The data collection logic 154 may further analyze such data periodically at a predetermined and/or preprogrammed interval. By verifying the sensor identifier data 142 stored in the data storage device 140 and/or connection of the external power source 18 to the transceiver 100, the operating logic 152 of the transceiver 100 may accurately determine an operating state/mode of the transceiver 100. For instance, the operating logic 152 of the transceiver 100 may determine that the external power source 18 is coupled to the transceiver 100 such that the operating logic 152 may execute one or more processes in response, such as operating the transceiver 100 in an active operational mode as will be described in greater detail herein. In other instances, the operating logic 152 of the transceiver 100 may determine that the external power source 18 is not coupled to the transceiver 100 such that the operating logic 152 may execute one or more processes in response, such as transitioning the transceiver 100 to a battery storage mode as will be described in greater detail herein.

The battery 160 is a device that serves as an internal power supply to one or more components in the transceiver 100. In some embodiments, the battery 160 is configured to provide power to the transceiver 100, and more specifically to the processor 110, the I/O hardware 120, and the network interface hardware 130 of the transceiver 100. The battery 160 is operable to provide power to the one or more components of the transceiver 100 via various suitable mechanisms, including one or more wired connections, wireless signals, and/or the like. In some embodiments, the battery 160 is an electric battery or other power-distribution systems.

It should further be understood that the components of the transceiver 100 illustrated in FIG. 2 are merely illustrative and are not intended to limit the scope of this disclosure. More specifically, while the components in FIG. 2 are illustrated as residing within the transceiver 100, this is a nonlimiting example. In some embodiments, one or more of the components may reside external to the transceiver 100. The computing device 12 may receive the sensor recording data 144 from the transceiver 100, analyze the sensor recording data 144, and estimate a state and/or condition of the one or more tires 15 of the vehicle 16 based on the sensor recording data 144. It should be understood that in the present example the computing device 12 is remotely located relative to the transceiver 100.

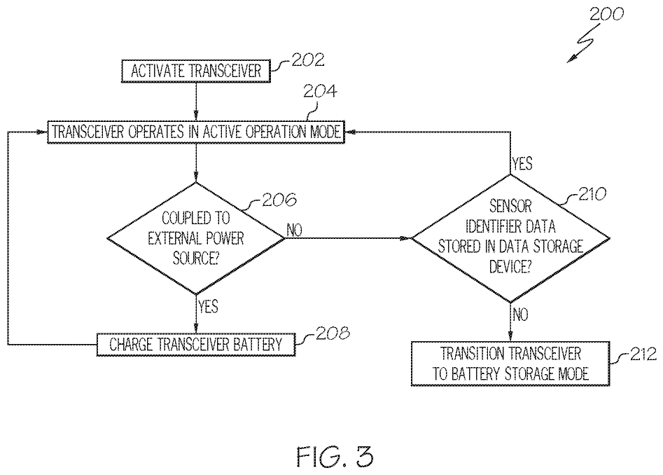

As mentioned above, the various components of the tire pressure monitoring system 10 described with respect to FIGS. 1-2 may be used to carry out one or more processes and/or provide functionality for transitioning the transceiver 100 from an active operation mode to a battery storage mode. The various components of the transceiver 100 may further be used to carry out one or more processes and/or provide functionality for maintaining and/or preserving a battery life of the tire pressure monitoring system 10, and in particular, the battery 160 of the transceiver 100 by transitioning an operating mode from an active operation mode where the battery 160 is primarily used to power operations of the transceiver 100 to a battery storage mode where the transceiver 100 is not configured to receive sensor recording data 144 from the vehicle 16 and power consumed by the battery 160 is less than when the transceiver 100 is in the active operation mode. An illustrative example of the various processes is described with respect to FIG. 3.

FIG. 3 schematically depicts a flow diagram of an illustrative method 200 of transitioning the transceiver 100 between an active operation mode and a battery storage mode to thereby improve a battery life of the transceiver 100. Initially, the transceiver 100 is activated at step 202 in response to an application of electrical power to the transceiver 100. In some embodiments, the transceiver 100 may be activated in response to a user input, such as at the network interface hardware 130, to initiate electric power transmission to the transceiver 100. In this instance, the transmission of electric power to the transceiver 100 is from the external power source 18. In other embodiments, the transceiver 100 may be activated in response to a connection of the external power source 18 to the transceiver 100, such as when the operating logic 152 includes instructions that, when executed by the processor 110, determine that the external power source 18 is electrically connected to the transceiver 100 such that the transceiver 100 may receive power from the external power source 18. In this instance, the transmission of electric power to the transceiver 100 is from the external power source 18. At step 204, the processor 110 of the transceiver 100 executes the operating logic 152 of the transceiver 100 to operate the transceiver 100 in an active operation mode upon activation of the transceiver 100 at step 202. In other words, in response to the transceiver 100 being activated at step 202, the operating logic 152 of the transceiver 100 causes the processor 110 to transition the transceiver 100 to the active operation mode. The processor 110 of the transceiver 100 further executes the operating logic 152 to determine whether the transceiver 100 is coupled to the external power source 18 at step 206. In some embodiments, the operating logic 152 includes instructions that, when executed by the processor 110, determine that the external power source 18 is electrically connected to the transceiver 100 such that the transceiver 100 may receive power from the external power source 18. In some embodiments, the I/O hardware 120 of the transceiver 100 communicates via the one or more networks 14 to determine the presence of an active connection (e.g., wireless) to the external power source 18 in order to determine that the transceiver 100 is coupled to the external power source 18 at step 206.

In response to determining that the transceiver 100 is in communication with and/or coupled to the external power source 18 at step 206, the processor 110 of the transceiver 100 executes the operating logic 152 to charge the battery 160 of the transceiver 100 while the external power source 18 is coupled thereto, at step 208. In this instance, a battery life of the tire pressure monitoring system 10, and more specifically the transceiver 100, is restored as the transceiver 100 continues to operate in the active operation mode. In other words, the operating logic 152 of the transceiver 100 is configured to return the executed method 200 to step 204 to continue operation of the transceiver 100 in the active operation mode as the battery 160 is being charged by the external power source 18. In other embodiments, the external power source 18 is configured to charge the battery 160 of the transceiver 100 when a power level of the battery 160 is below a predetermined charge threshold. The operating logic 152 is operable to periodically execute the steps 206 and 208 at a preprogrammed interval in response to the processor 110 executing step 204 of the method 200 such that the transceiver 100 periodically verifies whether the external power source 18 remains coupled to and in communication with the transceiver 100.

Still referring to FIG. 3, in response to determining that the transceiver 100 is not coupled to the external power source 18 at step 206, the processor 110 of the transceiver 100 executes the operating logic 152 to determine whether the data storage device 140 of the transceiver 100 includes the sensor identifier data 142 stored thereon at step 210. In this instance, the battery 160 of the transceiver 100 provides the power supply in lieu of the external power source 18 to thereby facilitate the determination of whether the sensor identifier data 142 is stored in the data storage device 140. While step 210 is executed in response to determining that the transceiver 100 is not coupled to the external power source 18 at step 206, in some embodiments, step 210 may be executed continuously and/or during at least one instance where the transceiver 100 was externally coupled to the external power source 18.

At step 210, the operating logic 152 determines whether sensor identifier data 142 is stored in the data storage device 140. In some embodiments, the operating logic 152 verifies whether the transceiver 100 is in communication with and has received unique serial numbers as the sensor identifier data 142 of one or more sensors 17 of the vehicle 16. It should be understood the sensor identifier data 142 is generated and stored in the data storage device 140 when the transceiver 100 is in active use, and more specifically when the transceiver 100 is coupled to one or more sensors 17 of the vehicle 16 for purposes of receiving sensor recording data 144 of the tires 15. With the data storage device 140 including at least one sensor identifier data 142 thereon, the operating logic 152 of the transceiver 100 verifies that the transceiver 100 is in active use by a user of the tire pressure monitoring system 10 such that the transceiver 100 is to remain operating in the active operation mode.

In response to determining that the data storage device 140 of the transceiver 100 includes the sensor identifier data 142 stored thereon at step 210, the processor 110 of the transceiver 100 executes the operating logic 152 to return to step 204 and continue operation of the transceiver 100 in the active operation mode. In other words, the transceiver 100, and more specifically the battery 160, is maintained in the active operation mode when the operating logic 152 verifies the transceiver 100 is coupled to at least one sensor 17 from the vehicle 16 due to a presence of at least one sensor identifier data 142 in the data storage device 140. Accordingly, the battery 160 provides power to the processor 110 of the transceiver 100 to execute the operating logic 152 and/or the data collection logic 154 of the transceiver 100 during continued use of the tire pressure monitoring system 10.

It should be understood that in some embodiments the sensor identifier data 142 of a sensor 17 is received at and stored on the data storage device 140 of the transceiver 100 when the transceiver 100 is initially coupled to at least one sensor 17 of the vehicle 16. Accordingly, the data storage device 140 of the transceiver 100 maintains the sensor identifier data 142 thereon for each of the sensors 17 that the transceiver 100 is in communication with (e.g., via the one or more networks 14) until the sensor identifier data 142 is removed from the data storage device 140, such as by user input received via the computing device 12. Returning to step 204, the operating logic 152 is operable to periodically execute step 206 at a preprogrammed interval in response to the processor 110 executing step 204 such that the transceiver 100 periodically reassesses whether the external power source 18 is coupled to the transceiver 100 prior to executing step 210 to determine whether the sensor identifier data 142 remains stored on the data storage device 140.

Still referring to FIG. 3, in response to determining that the data storage device 140 of the transceiver 100 does not include the sensor identifier data 142 stored thereon at step 210 and in response to the determination that the transceiver 100 is not coupled to the external power source 18 at step 206, the processor 110 of the transceiver 100 executes the operating logic 152 to transition the transceiver 100 from the active operation mode to the battery storage mode. In some embodiments, transitioning the transceiver 100 from the active operation mode to the battery storage mode includes terminating power distribution from the battery 160 to the other components of the transceiver 100. In this instance, the transceiver 100, and more specifically the battery 160, transitions from the active operation mode to the battery storage mode such that the battery 160 of the transceiver 100 is deactivated, or such that the battery power drained from the battery 160 is minimized while the transceiver 100 is in the battery storage mode. In some embodiments, the transceiver 100 is effectively rendered inoperable and power to the processor 110 is terminated such that the processor 110 is inhibited from executing the operating logic 152 and/or the data collection logic 154 unless and until the transceiver 100 is connected to an external power supply (e.g. the external power source 18). In this instance, a remaining battery life of the battery 160 of the transceiver 100 is preserved as the tire pressure monitoring system 10 is maintained in the battery storage mode in response to ceasing power consumption by the battery 160.

It should be understood that the transceiver 100, and in particular the data storage device 140 of the transceiver 100, may be devoid of the sensor identifier data 142 in instances where the transceiver 100 is initially activated at step 202 for quality control purposes during a manufacturing process of the transceiver 100. In this instance, the sensor identifier data 142 is temporarily uploaded onto the data storage device 140 for purposes of verifying an adequate performance and functionality of the one or more components of the transceiver 100 prior to deploying the transceiver 100 into the field for active use by a user. During said quality control testing of the transceiver 100, the transceiver 100 may be coupled to the external power source 18 to thereby charge the battery 160. Upon completion of the quality control testing of the transceiver 100, the external power source 18 may be disconnected from the battery 160 and the sensor identifier data 142 may be removed from the data storage device 140.

Pursuant to the method 200 of FIG. 3, a power consumption of the transceiver 100 is terminated as the transceiver 100 is transitioned from the active operation mode to the battery storage mode at step 212. Accordingly, a remaining battery life of the battery 160 is maintained and/or preserved such that the battery 160 does not supply electrical power to the one or more components of the transceiver 100, and in particular the processor 110 until the transceiver 100 is activated again at step 202 and transitioned to the active operation mode.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
operating a transceiver of a tire pressure monitoring system in an active operation mode, the transceiver including a battery and a data storage device;
determining whether the transceiver is coupled to an external power source;
determining whether the data storage device of the transceiver includes sensor identifier data stored thereon when the transceiver is not coupled to the external power source; and
transitioning the transceiver from the active operation mode to a battery storage mode when the data storage device does not include sensor identifier data stored thereon and the transceiver is not coupled to the external power source.

2. The method of claim 1, further comprising charging the battery of the transceiver when the battery is coupled to the external power source.

3. The method of claim 1, further comprising operating the transceiver in the active operation mode upon activation of the transceiver.

4. The method of claim 3, further comprising maintaining the transceiver in the active operation mode when determining that the data storage device includes sensor identifier data stored thereon.

5. The method of claim 1, further comprising periodically re-determining whether the battery is coupled to the external power source at a preprogrammed interval when the battery is coupled to the external power source or the data storage device includes sensor identifier data.

6. The method of claim 1, wherein the tire pressure monitoring system includes one or more sensors coupled to one or more tires of a vehicle such that the one or more sensors is operable to detect characteristics of the one or more tires.

7. The method of claim 6, further comprising receiving the sensor identifier data from the one or more sensors when the transceiver is communicatively coupled thereto such that the transceiver is in the active operation mode.

8. The method of claim 1, further comprising ceasing power consumption from the battery when the transceiver is in the battery storage mode.

9. The method of claim 1, wherein the sensor identifier data comprises a serial number assigned to one or more sensors of the tire pressure monitoring system.

10. The method of claim 1, further comprising:
receiving sensor recorded data at the transceiver when the data storage device does include sensor identifier data stored thereon; and
transmitting the sensor recorded data from the transceiver to a remote computing device.

11. A transceiver comprising:
a battery configured to power the transceiver;
a processor;
a data storage device; and
a memory including one or more programming instructions that, when executed by the processor, cause the processor to:
determine whether the transceiver is coupled to an external power source;
determine whether sensor identifier data of at least one sensor is stored in the data storage device; and
in response to determining the sensor identifier data of the at least one sensor is not stored in the data storage device and determining the transceiver is not coupled to the external power source, transition the transceiver from an active operation mode to a battery storage mode.

12. The transceiver of claim 11, wherein the transceiver includes network interface hardware communicatively coupled to at least one other component of a tire pressure monitoring system.

13. The transceiver of claim 11, wherein the one or more programming instructions included in the memory, when executed by the processor, cause the processor to charge the battery in response to determining the battery is coupled to the external power source.

14. The transceiver of claim 11, wherein the one or more programming instructions included in the memory, when executed by the processor, cause the processor to transition the battery to the active operation mode upon activation of the transceiver.

15. The transceiver of claim 14, wherein the one or more programming instructions included in the memory, when executed by the processor, cause the processor to maintain the transceiver in the active operation mode in response to determining the sensor identifier data of the at least one sensor is stored in the data storage device.

16. A tire pressure monitoring system comprising:
at least one sensor coupled to at least one tire of a vehicle, the at least one sensor including a sensor identifier; and
a transceiver, including:
a battery;
a processor;
a data storage device; and
a memory including one or more programming instructions that, when executed by the processor, cause the processor to:
determine whether the transceiver is coupled to an external power source;
determine whether the data storage device includes the sensor identifier stored therein; and
transition the transceiver from an active operation mode to a battery storage mode in response to determining the data storage device does not include the sensor identifier stored therein and determining the transceiver is not coupled to the external power source.

17. The tire pressure monitoring system of claim 16, wherein the one or more programming instructions, when executed by the processor, cause the processor to charge the battery in response to determining the transceiver is coupled to the external power source.

18. The tire pressure monitoring system of claim 16, wherein the one or more programming instructions, when executed by the processor, cause the processor to transition the transceiver to the active operation mode upon activation of the transceiver.

19. The tire pressure monitoring system of claim 18, wherein the one or more programming instructions, when executed by the processor, cause the processor to maintain the transceiver in the active operation mode in response to determining the data storage device includes the sensor identifier stored therein.

20. The tire pressure monitoring system of claim 16, wherein the one or more programming instructions, when executed by the processor, cause the processor to periodically determine whether the transceiver is coupled to the external power source at a preprogrammed interval.
